(19) United States
(12) Patent Application Publication
(10) Pub. No.: US 2025/0026681 A1
(43) Pub. Date: Jan. 23, 2025

(54) GLASS OR GLASS-CERAMIC PLATE

(71) Applicant: EUROKERA S.N.C., CHATEAU-THIERRY (FR)

(72) Inventors: Erwann LUAIS, CHATEAU THIERRY (FR); Julien LEJAY, Cedex VEDENE (FR); Dominique BILLIERES, Cedex VEDENE (FR)

(73) Assignee: EUROKERA S.N.C., CHATEAU-THIERRY (FR)

(21) Appl. No.: 18/714,251

(22) PCT Filed: Nov. 25, 2022
(86) PCT No.: PCT/FR2022/052176

§ 371 Date: May 29, 2024

(30) Foreign Application Priority Data
Nov. 30, 2021 (FR) FR2112704

(51) Int. Cl. C03C 17/25; C03C 10/00

(52) U.S. Cl. CPC C03C 17/25; C03C 10/0027; C03C 2201/54; C03C 2204/04; C03C 2217/214; C03C 2218/112

(57) ABSTRACT

The invention relates to a glass or glass-ceramic plate comprising a glass or glass-ceramic substrate coated with a metal-oxide-based coating, characterized in that said coating has a coverage rate of 25% to 90% and the coated plate has a roughness RSm less than or equal to 300 μm, preferably less than or equal to 250 μm.

The present invention relates to a glass or glass-ceramic plate. More specifically, it relates to a glass or glass-ceramic plate intended to serve as a furniture surface and/or a cooking surface as well as an article comprising such a glass or glass-ceramic plate.

Glass-ceramic plates are traditionally used as cooking plates. They also find applications in fields requiring heat resistance, for example to form fireplace inserts. Recently, their use has been extended to other areas of everyday life: glass-ceramic plates can be used as furniture surfaces, in particular to form worktops, central islands, consoles, etc. The surface area they occupy in these new applications is larger than in the past. For certain applications, glass plates may be an alternative to glass-ceramic plates, in particular for covering furniture, but also for cooking plates under certain conditions. Depending on their use, the glass or glass-ceramic plates may be provided with keys, touch-sensitive regions, buttons or other controls, their surface in all cases (even in the case of a simple furniture surface) being subjected to multiple contacts related to their uses which generally cause the appearance of unattractive finger marks at the points of contact, thus potentially leading to repeated cleaning operations, in particular when the plates are dark. These marks or stains may also lead to interference with the other optional components (heating elements, light sources, displays, etc.) of the article.

In order to avoid finger prints on the surface of the products, it is known in certain fields to apply hydrophobic and oleophobic coatings making it possible to limit the quantity of liquid(s) (water, sebum) deposited during contact with the finger. However, such coatings, which must be applied over the entire surface to be protected, are not thermally resistant, which poses problems for applications of the cooking plate type.

In the field of glass-ceramics, existing textures or coatings are generally not suitable for systematically resolving the problems of finger marks. The most frequently used coatings are especially coatings chosen to withstand high temperature, such as enamels, used locally to form decorative patterns or signaling, for example, heating regions, or paints used rather in flat form as opacifiers. However, these traditional coatings generally do not hinder the finger marks related to the handling and use of the coated substrates. Enamels can further locally reduce the mechanical strength of the glass-ceramic plates and can chip. Paints are also not suitable for all heating modes for the cooking plates due to their lower resistance, in particular thermal resistance. It is also known to use other coatings based in particular on thin metal layers deposited flat over a large portion of the surface of the substrate, but such layers sometimes contribute to the problems of finger marks.

The present invention proposes an improved glass or glass-ceramic plate making it possible to limit the visibility of finger marks on its surface, in particular a glass or glass-ceramic plate intended to be used with one or more heating elements such as a cooking plate, or intended to serve as a furniture surface. The plate according to the invention has anti-finger mark properties, without harming the other properties desired for its use, in particular their ease of maintenance and cleaning, its mechanical strength, in particular resistance to scratches and abrasion, and if applicable its thermal resistance.

The present invention relates to a plate comprising a glass or glass-ceramic substrate coated with a metal-oxide-based coating, in particular aluminum oxide or mixed aluminum oxide, characterized in that said coating has a coverage rate of 25% to 90% and the plate, that is, the coated substrate, has a roughness RSm of less than or equal to 300 μm, preferably less than or equal to 250 μm.

The substrate is preferably a glass-ceramic substrate, in particular a lithium aluminosilicate glass-ceramic substrate. The chemical composition of the glass-ceramic substrate typically comprises (or essentially consists of) the following constituents within the limits defined below, expressed as percentages by weight and whose sum is between 97 and 100%:
SiO₂ 52-75%
Al₂O₃ 18-27%
Li₂O 2.5-5.5%
K₂O 0-3%
Na₂O 0-3%
ZnO 0-3.5%
MgO 0-3%
CaO 0-2.5%
BaO 0-3.5%
SrO 0-2%
TiO₂ 1.2-5.5%
ZrO₂ 0-3%

The substrate may also be a glass substrate, the composition of which is of the lithium aluminosilicate, borosilicate or alumino-borosilicate type.

The chemical composition of the lithium aluminosilicate-type glass typically comprises (or essentially consists of) the following constituents, varying within the weight limits defined below:
SiO₂ 49-75%
Al₂O₃ 15-30%
Li₂O 1-8%
K₂O 0-5%
Na₂O 0-5%
ZnO 0-5%
MgO 0-5%
CaO 0-5%
BaO 0-5%
SrO 0-5%
TiO₂ 0-6%
ZrO₂ 0-5%
B₂O₃ 0-5%.

The chemical composition of the borosilicate-type glass typically comprises (or essentially consists of) the following constituents, varying within the weight limits defined below:
SiO₂ 70-85%
B₂O₃ 8-16%
Al₂O₃ 0-5%
RO 0-10%
K₂O 0-2%
Na₂O 1-8%.

The chemical composition of the alumino-borosilicate-type glass typically comprises (or essentially consists of) the following constituents, varying within the weight limits defined below and the sum of which is between 97 and 100%:
SiO₂ 45-68%,
Al₂O₃ 8-20%
B₂O₃ 4-18%
RO 5-30%
R₂O no more than 10%.

The expression “RO” denotes alkaline earth oxides MgO, CaO, SrO and BaO, while the expression “R₂O” denotes alkali metal oxides, in particular Na₂O and K₂O.

The expression “consists essentially of” within the meaning of the present invention means the mentioned oxides making up at least 95%, or even 97% or even 99% by weight of the composition. Regardless of the composition of the plate, the latter usually comprises additives used for refining. The refining agents are typically selected from oxides of arsenic, of antimony, of tin, and of cerium, halogens, and metal sulfides, in particular zinc sulfide. The amount by weight of refining agents is normally not more than 1%, preferably between 0.1% and 0.6%. The plate is generally bulk-colored. The composition thus in general comprises colorants, in particular chosen from vanadium oxide, iron oxide, cobalt oxide, cerium oxide, selenium oxide, chromium oxide, or even nickel oxide, copper oxide and manganese oxide. In the case of a glass-ceramic plate, the latter is preferably a glass-ceramic colored with vanadium oxide. It may comprise from 0.01 to 0.5% by weight of vanadium oxide optionally in combination with other dyes such as iron oxide, cobalt oxide or manganese oxide.

The glass or glass-ceramic substrate typically has a light transmission of less than 65%, or even less than 40%, or less than 20%, or even less than 10%. It is preferably less than 5%, in particular in the case of a glass-ceramic substrate, in particular colored with vanadium oxide. The light transmission is measured according to standard EN 410:2011 under illuminant D65, taking into account both direct and diffuse transmission. It can be measured using a spectrometer provided with an integrating sphere.

The substrate is preferably a dark substrate, that is, it has a lightness L*, as defined in the L*a*b* system, of less than 50, preferably less than 40, more preferentially less than 30.

The substrate is in the form of a plate which typically has a thickness of from 2 to 15 mm, in particular 3 to 10 mm, for example 4, 5, 6, 7 or 8 mm. The dimensions (length and width) of the plate depend on the application for which it is intended: it generally has dimensions of from 20 to 120 cm, in particular for these applications in cooking devices, but may also have greater dimensions, for example a width that may range up to 120 cm, or even 180 cm, and a length greater than 200 cm, for worktop applications.

The substrate preferably has a linear thermal expansion coefficient of at most 50.10⁻⁷ K⁻¹. In the case of a glass substrate, it typically has a linear thermal expansion coefficient of 25 to 45.10⁻⁷ K⁻¹. In the case of a glass-ceramic substrate, the absolute value of the expansion coefficient is typically less than 25.10⁻⁷ K⁻¹ or even less than 15.10⁻⁷ K⁻¹, or even less than 5.10⁻⁷ K⁻¹. The linear thermal expansion coefficient is measured according to standard ISO 7991:1987 between 20 and 300° C.

The coating is preferably based on aluminum oxide, titanium oxide, niobium oxide, zirconium oxide or mixed oxide thereof, in particular mixed aluminum oxide, more preferentially aluminum oxide or mixed aluminum oxide. “Based on” is understood to mean that the coating generally comprises at least 50% by weight of the considered oxide, preferably at least 60% and even 70% or 80%, or even 90%, 95% or 99% by weight of this element. In some cases, the coating may consist of this oxide, except impurities.

The mixed aluminum oxide is preferably chosen from binary or ternary aluminum oxides, in particular from mixed aluminum and titanium oxides, mixed aluminum zirconium oxides and mixed aluminum, titanium and silicon oxides, preferentially from mixed aluminum and titanium oxides and mixed oxides of aluminum, titanium and silicon. The coating preferably comprises at least 30% by weight, preferably at least 40% to 80%, alumina relative to the total weight of the oxides. Interestingly, a coating based on mixed aluminum and titanium oxide makes it possible to maintain relatively low clarity and relatively high gloss, particularly appreciated for applications as a cooktop.

The coating according to the invention is typically obtained by spraying a metal oxide-based material, in particular aluminum oxide or mixed aluminum oxide, in powder form. These deposition methods consist in spraying powder particles, preferably molten, at a very high speed. The particles arriving on a surface to be coated are crushed in the form of drops (splats).

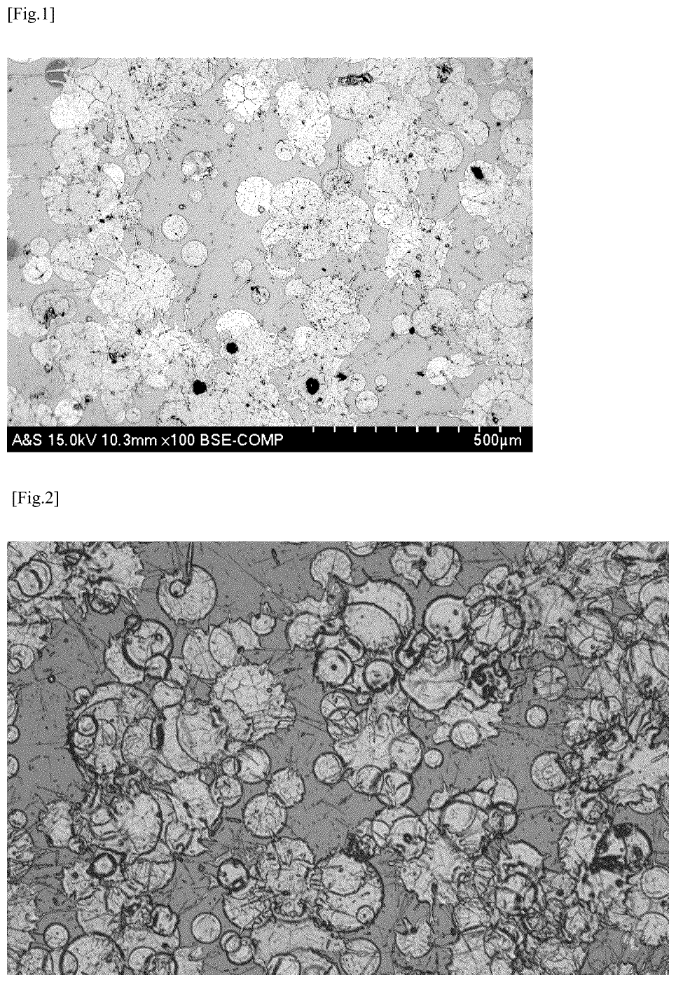

The coating according to the invention is generally a discontinuous deposition. The coating is typically in the form of a surface distribution of solid drops of a metal oxide-based material, in particular aluminum oxide or mixed aluminum oxide, randomly distributed on the surface of the plate. This type of coating is typically obtained by thermal spraying, in particular by plasma spraying, by oxy-gas flame spraying or by high-speed thermal spraying, preferably by plasma spraying. As shown in FIG. 1 depicting an SEM image of a coating according to the invention, on the scale of a few hundred microns (for example, 500 μm), some regions are covered with drops, which can overlap or be superimposed, while other regions are not covered. The coverage rate is greater than or equal to 25%, preferably greater than or equal to 35% and less than or equal to 90%, preferably less than or equal to 80%. The coverage rate is more preferentially from 30 to 70%, or even from 40 to 60%. In certain embodiments, it may be less than or equal to 50%, in particular from 35 to 50%, or greater than or equal to 50%, in particular from 60 to 90%. For the purposes of the present invention, “coverage rate” refers to the ratio, expressed as a percentage, of the surface of the plate actually covered by the surface dispersion of drops of aluminum oxide-based material or mixed aluminum oxide-based material to the total surface theoretically covered by the coating (the surface of the plate whereupon the coating was deposited). The coverage rate is measured by image analysis taken under an optical microscope, followed by image processing by thresholding and binarization. The coverage rate corresponds to the ratio of the pixels corresponding to the coating (generally the white pixels) to all of the pixels. The coverage rate is typically measured on coating regions of 0.9 mm² (typically 1.1 mm×0.8 mm) to 3.7 mm² (typically 2.3 mm×1.6 mm) and ideally averaged over 3 to 10 regions.

The average diameter of the drops is preferably from 10 to 200 μm, more preferentially from 20 to 160 μm. The average diameter of the drops is measured by image analysis from optical microscopies.

The plate according to the invention has a roughness RSm less than or equal to 300 μm, preferably from 50 to 250 μm. The ratio Ra/Rsm is preferably greater than or equal to 0.0030, and typically less than or equal to 0.1000, and more preferentially from 0.0030 to 0.0500, or even from 0.0035 to 0.0100. It generally has a roughness Ra of less than or equal to 2.5 μm, preferably less than or equal to 2.0 μm, or even less than or equal to 1.5 μm, and typically greater than or equal to 0.3 μm. The roughness Rdq is preferably 3.0 at 25.0°. The coated plate preferably has a roughness of Rz greater than or equal to 3.0 μm, or even greater than or equal to 3.5 μm and typically less than or equal to 20 μm, preferably less than or equal to 15 μm. The roughness Rt is typically greater than or equal to 5 μm and preferably less than or equal to 15 μm or less than or equal to 9 μm.

The roughnesses RSm, Ra, Rdq, Rz and Rt are defined in a conventional manner according to standard ISO 4287:1997. It goes without saying that the characteristic roughness parameters of the present invention are measured on the surface coated with a coating according to the invention. RSm represents the average width of the elements of the roughness profile corresponding to the average value of the widths of the elements of the profile within a base length. Ra represents the average deviation of the roughness profile corresponding to the arithmetic mean of the absolute values of the deviations between the successive peaks and troughs within a base length. Rdq represents the mean square slope of the roughness profile corresponding to the mean square value of the local slopes within a base length. Rz represents the maximum height of the roughness profile corresponding to the sum of the largest of the protrusion heights of the roughness profile and the largest of the trough depths of the roughness profile within a base length. Rt represents the total height of the roughness profile corresponding to the sum of the largest of the protrusion heights of the roughness profile and the largest of the trough depths of the roughness profile within the evaluation length. The roughnesses RSm, Ra, Rdq and Rz are measured over a base length of 0.8 mm and the roughness Rt over an evaluation length of 4 mm using a contact roughness tester such as the Mitutoyo SJ-401 roughness tester.

In some embodiments, the coating has a coverage rate of 30 to 70%, preferably 40 to 60%, and the plate has a roughness RSm less than or equal to 250 μm, a roughness Ra less than 1.5 μm and a ratio Ra/RSm of 0.003 to 0.01. Indeed, it has been observed that these embodiments, apart from reducing the visibility of finger marks, provide the glass or glass-ceramic plate with improved mechanical properties (improved scratch resistance and/or decreased visibility of scratches) and do not generate excessive haze, thus ensuring good visibility of the displays placed below the plate.

Another subject matter of the present invention relates to a method for manufacturing a glass or glass-ceramic plate as described above comprising depositing a metal oxide-based coating by thermal spraying on the surface of a glass or glass-ceramic substrate, characterized in that the surface of the substrate is at a temperature greater than 300° C. during the deposition of the coating.

The so-called thermal spraying methods are well known to a person skilled in the art. It may in particular be plasma spraying, oxy-gas flame spraying or high-speed thermal spraying (or HVOF: High Velocity Oxy-Fuel). The particles of the powder to be sprayed are brought to temperatures above the melting temperature of the powder. The drops deposited adhere to the substrate mainly due to the diffusion of atoms at the substrate/droplet interface or mechanically owing to the plastic deformation of the particles, and to a lesser extent by Van der Waals forces.

The coating according to the invention is preferably obtained by plasma spraying. The spraying parameters such as the electrical power, the total flow rate of plasma gas, the composition of the plasma gases, the powder flow rate, the linear speed of the torch and the number of passes are adjusted in a manner well known to a person skilled in the art, depending on the type of torch and the characteristics of the powder used, to generate a stream of properly melted particles at an adequate speed so as to obtain spreads of non-burst, adherent and low-cracking drops and to obtain a coating according to the invention. For example, in the case of plasma spraying using a plasma torch of the Proplasma HP8 type sold by Saint-Gobain Coating Solutions, the electrical power may be from 30 to 65 KW, the total gas flow rate from 40 to 80 L/min, the powder flow rate from 0.5 to 15 g/min, the linear movement speed of the torch from 1,000 to 5,000 mm/s, the advance pitch is 3 to 15 mm and the number of passes from 1 to 10. The powder flow rate, the linear speed of movement of the torch, the advance pitch (distance separating 2 movement lines of the torch) as well as the number of passes make it possible in particular to modulate the coverage rate and the roughness of the coating according to the invention.

The powder used in the method according to the invention is generally identical in nature to the desired coating, that is, a metal oxide powder, in particular an aluminum oxide powder or mixed aluminum oxide, preferably chosen from binary or ternary aluminum oxides, in particular from mixed aluminum and titanium oxides and mixed oxides of aluminum, titanium and silicon.

The powder typically has a particle size such that the diameter D₁₀ is between 3 and 20 μm, and such that the diameter D₉₀ is between 20 and 75 μm. The diameters D₁₀, respectively D₉₀, are to be understood such that 10%, respectively 90%, by number of the particles of the powder have a diameter less than the value D₁₀, respectively D₉₀. They are determined by laser diffraction.

The powder is preferably a dense grain powder, that is, having a porosity of less than 1%. It is preferably powder resulting from a melting process (molten-ground) in order to improve the adhesion of the coating.

During the deposition of the coating according to the invention, the surface of the substrate is at a temperature greater than 300° C., preferably greater than 360° C., for example from 400 to 800° C., or even from 450 to 700° C. To this end, the substrate is heated before and/or during the deposition step. Indeed, it has been noted that the temperature of the substrate impacts the roughness of the deposit obtained.

Heat treatment can also be carried out after the deposition of the coating according to the invention to improve the adhesion thereof. In particular, in the case of a glass-ceramic plate, it may prove advantageous to deposit the coating on the mother glass, that is, before the ceramization heat treatment, to take advantage of the beneficial effect of the heat treatment on the adhesion of the coating.

The plate according to the invention may, where appropriate, be coated with other functional coatings (anti-overflow layer, opacifying layer, etc.) and/or decorative coatings, in particular localized, such as typical enamel-based patterns. By way of example, the plate may have a localized coating of decorative enamel, generally on the same face as the coating according to the invention, and in general above it (to form, for example, patterns or logos or delimiting/signaling certain regions, in particular heating regions), and/or an opacifying layer over all or part of the face of the plate opposite the coating according to the invention (for concealing, for example, internal elements arranged under the plate).

The plate according to the invention can be used for various applications such as worktops, in cooking devices, for example cooking plates, especially induction cooking plates, in fireplace inserts, in fire-resistant glazings or as a decorative element. Thus, the present invention also relates to an article, in particular a worktop, a cooking device, a fireplace insert, a fire-resistant glazing or a decorative element, comprising a glass or glass-ceramic plate as described above or obtained by the method described above. It is preferably a cooking device. Regardless of the application, the plate according to the invention is such that, in the use configuration, the coating according to the intention is arranged on the surface of the plate facing the user.

The article according to the invention may also comprise internal elements comprising heating means, a display device and/or a control device. The display device may be a light source, in particular light-emitting diodes or an LCD screen, optionally associated with optical filters or optical guides. The heating means may be chosen from radiant or halogen heating means, atmospheric gas burners, and induction heating means. The control device may be a touch-sensitive electronic control panel. The article can also be provided with (or associated with) additional functional element(s) such as a frame, stiffener(s), connector(s), cable(s), control element(s), etc.

The present invention is shown by the following nonlimiting examples.

Dark glass-ceramic plates of the KeraBlack+ type sold by the company Eurokera were coated by plasma spraying of various aluminum oxide-based coatings and mixed aluminum oxides. The depositions of the coatings are carried out on substrates heated to between 40° and 720° C. using an HP 8 torch sold by Saint-Gobain Coating Solutions. The spraying parameters for sample I1 are the following:
Electrical power: 53 KW
Total flow rate of plasma gases: 68 L/min
Torch-substrate distance: 130 mm
Powder flow rate: 2.5 g/min
Linear speed of the torch: 3000 mm/s
Advance pitch: 7 mm
Number of passes: 1

Samples C1 to C3 and I2 to I5 are obtained identically to sample I1, unlike certain spraying parameters, in particular the powder flow rate, the linear speed of the torch and the number of passes.

The aluminum oxide powders used are dense grains (molten-ground) has the following characteristics as follows:

TABLE 1

| Composition | AlTiOₓ | AlTiSiOₓ |
|---|---|---|
| Particle diameters | 15-45 | 5-25 |
| D₁₀-D₉₀ (μm) | | |

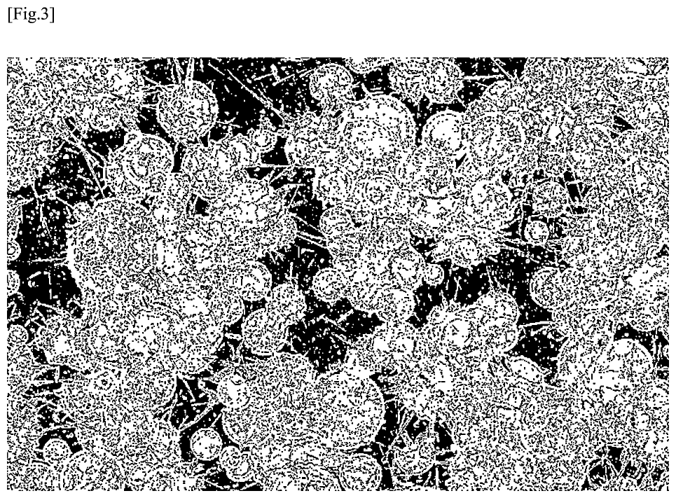

The coverage rate of the various coatings obtained was measured by image analysis taken with an optical microscope (Leica DMC 2900), followed by image processing using the ImageJ software. The processing consists in using the thresholding function (Threshold) of the software, by adjusting the gray levels and then binarizing the image so that the drops appear in white pixels and the non-covered surface appears black. FIG. 2 shows an image of a sample taken with an optical microscope and FIG. 3 shows the corresponding image after image processing allowing the calculation of the coverage rate.

The visibility of the finger marks on the coated samples was evaluated comparatively to the uncoated glass-ceramic reference sample according to the following protocol. Several fingerprints were carried out on the coated samples and on the uncoated glass-ceramic taken as reference. The evaluations of the observers were carried out the same day as the application of the finger, under the same illumination conditions with the Daylight illuminant in a SpectraLight Ill light booth sold by X-Rite, at an angle of 60° relative to the normal. The results are shown in table 2. (−) indicates a visibility of the finger marks identical to that of the uncoated glass-ceramic. (+) indicates a visibility of the finger marks inferior to that of the uncoated glass-ceramic.

The results are summarized in table 2. Samples I1 to I5 are examples according to the invention and examples C1 to C3 are comparative examples.

TABLE 2

| | Specimen | | | | | | | |
|---|---|---|---|---|---|---|---|---|
| | C1 | C2 | C3 | I1] | I2 | I3 | I4 | I5 |
| | Coating | | | | | | | |
| | AlTiSiOx | | | | | | AlTiOx | |
| Coverage | 32 | 16 | 24 | 31 | 42 | 87 | 47 | 70 |
| rate (%) | | | | | | | | |
| RSm (μm) | 336 | 417 | 338 | 233 | 130 | 86 | 170 | 154 |
| Ra/RSm | 0.0011 | 0.0013 | 0.0025 | 0.0037 | 0.0057 | 0.018 | 0.0037 | 0.0067 |
| Finger mark | (−) | (−) | (−) | (+) | (+) | (+) | (+) | (+) |
| visibility | | | | | | | | |

Samples I1 to I5 have significantly improved anti-finger mark properties compared to samples C1 to C3, which are not better than the uncoated reference glass-ceramic.

1. A plate comprising a glass or glass-ceramic substrate coated with a metal oxide-based coating, wherein said coating has a coverage rate of 25% to 90% and the plate has a roughness RSm less than or equal to 300 μm.

2. The plate according to claim 1, wherein the coating is obtained by thermal spraying.

3. The plate according to claim 1, wherein it has a roughness Ra such that the ratio Ra/RSm is greater than or equal to 0.0030.

4. The plate according to claim 1, wherein it has a roughness Ra of less than or equal to 2.5 μm.

5. The plate according to claim 1, wherein said coating has a covering rate is from 30 to 70%.

6. The plate according to claim 1, wherein said coating is based on aluminum oxide, titanium oxide, niobium oxide, zirconium oxide or mixed oxide thereof.

7. The plate according to claim 1, wherein said coating is based on mixed aluminum oxide.

8. The plate according to claim 1, wherein said coating is based on aluminum oxide, mixed oxide of aluminum and titanium, mixed oxide of aluminum and zirconium or mixed oxide of aluminum, titanium and silicon.

9. The plate according to claim 1, wherein the substrate exhibits a light transmission of less than 65%, preferably less than 5%.

10. The plate according to claim 1, wherein the substrate has a lightness L* of less than 50, preferably less than 40, more preferentially less than 30.

11. The plate according to claim 1, wherein the substrate is a glass-ceramic substrate having a chemical composition comprising the following constituents within the limits defined below, expressed as percentages by weight:
SiO₂ 52-75%
Al₂O₃18-27%
Li₂O 2.5-5.5%
K₂O 0-3%
Na₂O 0-3%
ZnO 0-3.5%
MgO 0-3%
CaO 0-2.5%
BaO 0-3.5%
SrO 0-2%
TiO₂ 1.2-5.5%
ZrO₂ 0-3%.

12. The plate according to claim 1, wherein the substrate is a glass substrate, the composition of which is of the lithium aluminosilicate, borosilicate or alumino-borosilicate type,

13. The plate according to claim 12, wherein the substrate is a borosilicate-type glass substrate having a chemical composition comprising the following constituents within the limits defined below expressed as weight percentages:
SiO₂ 70-85%
B₂O₃ 8-16%
Al₂O₃ 0-5%)
RO 0-10%
K₂O 0-2%
Na₂O 1-8%.

14. A method for manufacturing a glass or glass-ceramic plate according to claim 1 comprising depositing a metal oxide-based coating by thermal spraying on the surface of a glass or glass-ceramic substrate, wherein the surface of the substrate is at a temperature greater than 300° C. during the deposition of the coating.

15. An article comprising a glass or glass-ceramic plate as defined in claim 1 and internal elements comprising heating means, a display device and/or a control device.

16. The plate according to claim 1, wherein the plate has a roughness RSm less than or equal to 250 μm.

17. The plate according to claim 1, wherein:
the substrate has a lightness L*, as defined in the L*a*b* system, of less than 50;
the metal oxide-based coating is discontinuous,
the coating has a coverage rate of 30 to 70%; and
the plate has a roughness RSm less than or equal to 250 μm, a roughness Ra less than 1.5 μm, and a ratio Ra/RSm of 0.003 to 0.01.
